(19) United States
(12) Patent Application Publication
(10) Pub. No.: US 2007/0059395 A1
(43) Pub. Date: Mar. 15, 2007

(54) Molded article handling device

(75) Inventors: Nicholas W. Serniuck, Oakville (CA); Robin W. Lovell, Oakville (CA); Kenn J. Wu, Markham (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/224,190

(22) Filed: Sep. 12, 2005

(51) Int. Cl. B29C 45/80

(52) U.S. Cl. 425/150

(57) ABSTRACT

Disclosed herein is a molded article handling device, an apparatus, and a system. The device, the apparatus and the system include a slide bar configured to have a mold portion configured to mold, in cooperation with complementary mold halves of a molding machine, a molded article. The slide bar is also configured to be actuatable by an actuator. The actuator is configured to move the slide bar towards selectable positions, and the selectable positions located between travel terminus points.

### TECHNICAL FIELD

The present invention generally relates to molding machines, and more specifically the present invention relates to a molded article handling device usable with complementary mold halves of a molding machine.

### BACKGROUND OF THE INVENTION

FIG. 1 is a perspective view of a known molded article handling device 100 (hereinafter referred to as the “device” 100). The device 100 removes or ejects a molded article (not depicted) from complementary mold halves (not depicted) of a molding machine (not depicted). By way of example, the molded article is a PET preform.

The device 100 includes a stripper plate 102, a left-side slide bar 104, a right-side slide bar 106, a left-side mold portion 108, a right-side mold portion 110, a left-side connecting bar 114, a right-side connecting bar 112, a cam follower 116 and a cam 118.

The mold portions 108 and 110 mold, in cooperation with the complementary mold halves, the molded article. The complementary mold halves include a first mold half and a second mold half. The mold portions 108 and 110 are connected to the slide bars 104 and 106 respectively. The mold portions 108 and 110 include a cooling circuit for cooling the molded article after it is molded. The stripper plate 102 faces the first mold half while the slide bars 104 and 106 face the second mold half.

The stripper plate 102 is made to reciprocate between the complementary mold halves by an actuator (not depicted) along an axis that extends between the complementary mold halves. The axis extends along a clamping direction that the complementary mold halves reciprocate therealong. The slide bars 104 and 106 are slidably mounted to the stripper plate 102. The bars 104 and 106 are made to reciprocate along a direction that extends orthogonal to the axis extending between complementary mold halves.

The connecting bars 114 and 112 are connected to the slide bars 104 and 106 respectively. The cam follower 116 is connected to the connecting bar 114. Another cam follower (not depicted) is connected to the connecting bar 112. The cam follower 116 follows within a cam pathway defined by the cam 118, which is fastened (in effect) to the first mold half. When the stripper plate 102 is actuated to move by a hydraulic actuator (not depicted) along the axis extending between the complementary mold halves and away from the first mold half, the cam follower 116 is made to move along the cam pathway defined in the cam 118 and in this manner the slide bar 104 is moved perpendicular to the axis that extends between the complementary mold halves. The cam pathway is also called a cam profile. Disadvantageously, the problem is in establishing a suitable cam profile and/or changing the cam profile based upon changes made to a molding machine processing approach (such as, for example, increasing the cycle time of the molding machine).

U.S. Pat. No. 6,799,962 (Assignee: Husky Injection Molding Systems Limited; Inventor: Mai et al) discloses a stripper assembly for an injection molding machine comprising at least one slide pair having a first slide and a second slide and actuation means operatively coupled to said first slide for moving the first slide in a first direction. According to an important aspect of the invention, the stripper assembly further comprises transmission means operatively coupled to said first slide and said second slide for transforming the movement of the first slide in the first direction in a movement of the second slide in a second direction, the second direction being opposite to the first direction.

U.S. Pat. No. 5,531,588 (Assignee: Electra Form; Inventor: Brun et al) discloses an adjustable cam track for an injection molding machine includes a set of guides coupled to a moveable platen for guiding the movement of space defining surfaces which are movably mounted to a stripper platen as it moves with respect to the movable platen. A set of cam followers coupled to the space defining surfaces cause relative movement of each pair of surfaces to release molded articles previously striped from the molds of the molding machine. A set of cam inserts engage the cam followers and are adjustably positionable with respect to the guides to adjust the point of release of the molded articles. Each guide includes a pair of guide walls forming a channel defining two limits of position of the cam follower engaged therein. Each cam insert is received between the guide walls and includes a pair of cam insert walls spaced apart by a distance about equal to the size of the cam follower engaged therein to define a path of movement for the cam follower between the two limits of position. Each cam insert includes a first toothed rack, while a second toothed rack is removably fixed to each guide and engages the first toothed rack to fix the position of each cam insert relative to each guide only at certain preselected locations to coordinate the operation of all the cam followers thereby avoiding any wear imbalance.

U.S. Pat. No. 5,653,934 (Assignee: Electra Form; Inventor: Brun et al) discloses a molding machine including a mold for molding articles of plastic in the molding machine and apparatus for removing the molded articles from the molding machine. The mold includes molding elements movable by the molding machine in a first dimension between a closed conformation where the molding elements define cavities in which the articles are molded and an open conformation where the molding elements are separated from each other by a distance sufficient to permit release of the molded articles in a space between the molding elements. A first molding element includes channels situated on opposite sides of the molded articles for receiving the article removing apparatus while the molding elements are in the closed conformation. A cam track is fixed to the first molding element and a cam coupled to article holders is engaged in the cam track to move the article holders elements from a position aligned with the channels toward engagement with the molded articles as the molding elements open. A boom is coupled to the second molding elements and a trolley is coupled for linear movement along the boom, the article engaging elements being coupled to the trolley for movement out of the molding machine when it is open and into the channels when the molding machine is closed.

U.S. Pat. Nos. 6,799,962, 5,531,588 and 5,653,934 use cams, cam tracks and cam followers to move a stripper plate between a mold opened position and a mold closed position, and the stripper plate is not stoppable between these positions.

Patent WO 2004/068927 A2 (Assignee: Otto Hofstetter AG) attempts to overcome problems associated with the cam 118 by teaching the use of a hydraulic actuator as a replacement for the cam 118 and cam follower 116. The hydraulic actuator is used for shuttling (moving, translating) the slide bar 104. Disadvantageously, it appears that the degree or the amount of displacement of the slide bar 104 may not be suitably controlled by use of the hydraulic actuator. The hydraulic actuator is stroked between its end terminus “stroking” points (that is, points located between an opened position and a closed position).

According to the inventors, it is believed that it is difficult to control a degree of stroke of the Hofstetter hydraulic actuator (that is, it is not possible to stroke the hydraulic actuator to selected or selectable points located between two terminus travel points of the actuator). In other words, the Hofstetter hydraulic actuator includes and arm that is stroked between travel endpoints but does not have the ability to stop, start or vary the speed of motion at any of point between the travel end points. Hofstetter teaches: “The base plate 2 features an inclined pulling element 7 on the side, stepped at point C only to create a release stroke “h”. The release stroke “h” serves only to loosen the preforms from the male mold cones 5, to make sure the preforms will not remain sticking on these cones when the latter are fully opened. The base plate (2) features an inclined pulling element (7) that actuates the slide (4) in a way as to opening the male mold cones (5, 5′) at a certain point (C) between its closed (A) and removal (B) positions only by a slight release stroke (h) to prevent the preforms from sticking.” Therefore, in effect, Hofstetter limits the number of positions between end travel points to one point or one position. Also, it is believed that uncontrolled stroking of the Hofstetter hydraulic actuator may permit a slide bar to accidentally nick or blemish the molded article upon retraction of the molded article from the complementary mold halves. The problem, which is not resolved by Hofstetter, is resolved by the present invention by providing a slide bar that is configured to be actuated upon by an actuator, in which the actuator is configured to move the slide bar towards selectable positions with varying speeds and optional intermediate stops, in which the selectable positions are located between travel terminus points. Hofstetter does not contemplate more than one “h”. The purpose of implementing the “h” is to permit improved or easier releasing the preform from the surrounding structure and nothing more than that.

### SUMMARY OF THE INVENTION

The technical effect realized by the embodiments of the present invention and variations and alternatives thereof is the ease with which to reconfigure a preferred preform removal path so that a side bar does not accidentally nick or blemish a preform while the preform is retracted from complementary mold halves. This arrangement also reduces development time associated with configuring cams for use with the slide bar. Another advantage of some embodiments is changes in the preform removal pathway may be enabled in a convenient manner without physical alteration to the mold structure after it has been built. Advantageously, the present invention permits the establishment of a suitable cam profile and/or changing the cam profile based upon changes made to a molding machine processing approach (such as, for example, increasing the cycle time of the molding machine).

In a first aspect of the present invention, there is provided a molded article handling device, including a slide bar configured to have a mold portion configured to mold, in cooperation with complementary mold halves of a molding machine, a molded article, and the slide bar is also configured to be actuatable by an actuator, the actuator configured to move the slide bar towards selectable positions, the selectable positions located between travel terminus points.

In a second aspect of the present invention, there is provided an apparatus, including complementary mold halves of a molding machine, and also including a molded article handling device, the molded article handling device including a slide bar configured to have a mold portion configured to mold, in cooperation with the complementary mold halves, a molded article, and the slide bar is also configured to be actuatable by an actuator, the actuator configured to move the slide bar towards selectable positions located between end-travel terminus points.

In a third aspect of the present invention, there is provided a system, including a molding machine, the system also includes complementary mold halves cooperating with the molding machine, and the system also includes a molded article handling device, the molded article handling device including a slide bar configured to have a mold portion configured to mold, in cooperation with the complementary mold halves, a molded article, and the slide bar is also configured to be actuatable by an actuator, the actuator configured to move the slide bar towards selectable positions located between end-travel terminus points.

### BRIEF DESCRIPTION OF THE FIGURES

A better understanding of the exemplary embodiments of the present invention (including alternatives and/or variations thereof) may be obtained with reference to the detailed description of the exemplary embodiments along with the following drawings, in which:

FIG. 1 is a perspective view of a known molded article handling device;

FIG. 2 is a perspective view of a molded article handling device (MAHD) according to the preferred embodiment of the present invention;

FIG. 3 is a cross sectional view along A-A of the MAHD FIG. 2 for a mold closed position;

FIG. 4 is a cross sectional view of along A-A the MAHD of FIG. 2 for a mold opened position;

FIG. 5 is a schematic of a data processing system (DPS) usable with the MAHD of FIG. 2;

FIG. 6 is a flow chart of programmed removal instructions for directing the DPS of FIG. 5; and

FIG. 7 is a flow chart of programmed reset instructions for directing the DPS of FIG. 5.

### DETAILED DESCRIPTION OF THE EXEMPLARY EMBODIMENTS

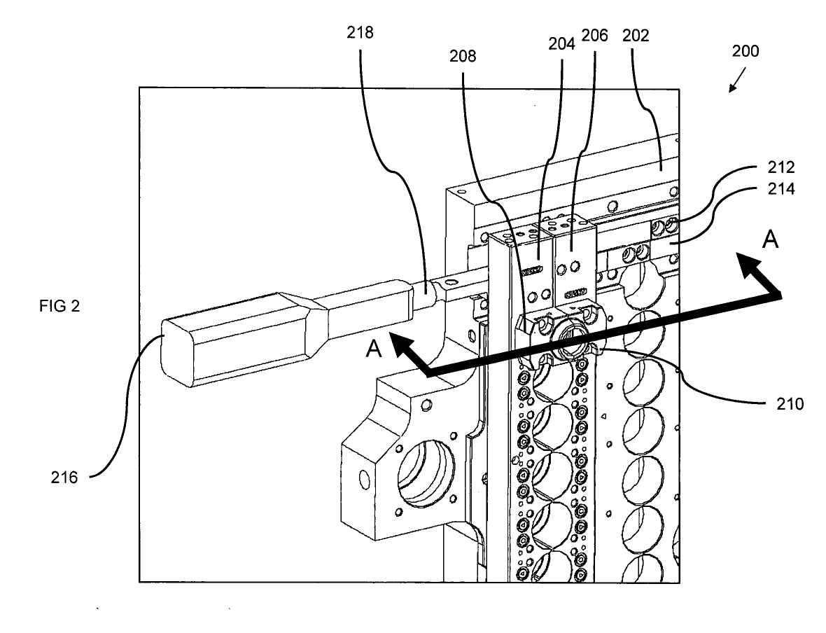

FIG. 2 is the perspective view of a molded article handling device 200 (hereinafter referred to as the “device” 200) according to the preferred embodiment. Alternatives and/or variations to the preferred embodiment will be identified and described further below during the course of describing the preferred embodiment.

Generally, the device 200 (according to the preferred embodiment) includes a left-side slide bar 204 (hereinafter referred to as the “slide bar” 204) and a left-side mold portion 208 (hereinafter referred to as the “mold portion” 208) that is fixedly attached to the slide bar 204. The mold portion 208 is used to mold, in cooperation with complementary mold halves (not depicted) of a molding machine (not depicted), a molded article (not depicted). The mold portion 208 includes a cooling mechanism that carries a coolant that cools a portion of the molded article. In other embodiments, the slide bar 204 is connected to a plurality of mold portions (not depicted) that are similar to the mold portion 208.

The device 200 also includes an actuator 216. The slide bar 204 is configured to be actuated upon by the actuator 216. The actuator 216, which is for example an electric servo motor drive or the like, when so energized moves the slide bar 204 towards selectable or selectable positions, in which the selectable positions are located between travel “end” terminus points of the actuator 216. A figure is not provided for illustrating an alternative variation in which the actuator 216 is connected directly to the slide bar 204. In a preferred variation, the actuator 216 is connected to either one of the connecting bars 212 or 214 so that a plurality of slide bars (not depicted) are connected to the connecting bars 212 and 214, and the complementary mold halves mold a matrix of preforms that need to be removed by the plurality of slide bars when so actuated to be moved by the actuator 216.

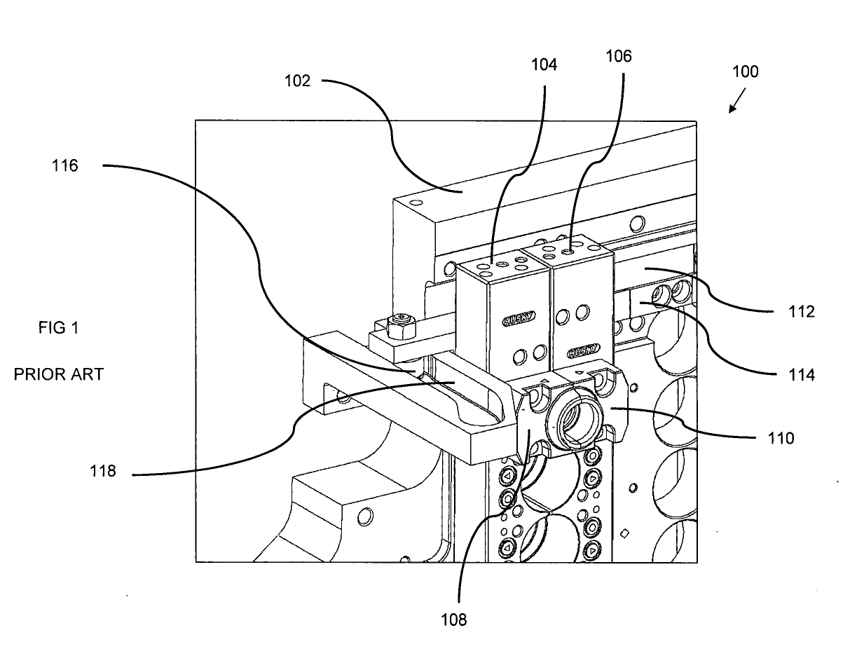

Specifically, the actuator 216 shuttles the slide bar 204 and the molded portion 208 away from the molded article as the molded article is ejected from the complementary mold halves. The actuator 216 is a replacement of the cam 118 and the cam follower 116 both depicted in FIG. 1. The actuator 216 imparts a force which displaces the slide bar 204. Preferably, a data processing system (not depicted) issues a command to the actuator 216, in which the issued command indicates an amount of displacement that the actuator 216 is required to impart to the slide bar 204 through a left-side connecting bar 214 (referred to hereinafter as the “connecting bar” 214) that connects the slide bar 204 to the actuator 216. The connecting bar 214 is used in alternative embodiments that include a plurality of slide bars that are similar to the slide bar 204. It will be appreciated that the data processing system and the actuator 216 may be supplied separately. In response to receiving the command from the data processing system, the actuator 216 shuttles the slide bar 204 towards selectable positions, in which the selectable positions are located between “end” travel terminus points of the actuator 216. The actuator 216 does shuttle the slide bar 204 between the “end” travel terminus points but (unlike the Hofstetter actuator) it is capable of stopping at (and/or moving towards) many selectable positions that are located between the travel terminus points. There is a distinction between the Hofstetter actuator and the actuator 216. The actuator 216 facilitates removal of the molded article from the mold portion 208 from the complementary mold halves in a way that is distinctly different that the Hofstetter actuator and in a manner that is more desirable as well. An example of the actuator 216 is Model CAPL32x100x1/D24CW manufactured by SKF of Norristown, Pa., USA. The actuator 216 includes a shaft 218 that is linearly movable from a first travel terminus point and a second travel terminus point. The actuator 216 shuttles the shaft 218 along the selectable or selectable positions, in which the selectable positions are located between the first and the second travel terminus points. Since the shaft 218 is connected to the connecting bar 214 which in turn is connected to the slide bar 204, the slide bar 204 is also made to be moved along these selectable positions under the command of control logic of the data processing system.

According to an alternative embodiment, the device 200 also includes a stripper plate 202, a right-side slide bar 206 (hereinafter referred to as the “slide bar” 206), a right-side mold portion 210 (hereinafter referred to as the “mold portion” 210), and a right-side connecting bar 212 (hereinafter referred to as the “connecting bar” 212).

The mold portions 208 and 210 mold, in cooperation with the complementary mold halves, the molded article. The mold portions 208 and 210 are connected to the slide bars 204 and 206 respectively. The mold portions 208 and 210 contain a cooling circuit (not depicted) for cooling the molded article after it is molded. The slide bars 204 and 206 are movable, by way of the stripper plate 202, along an axis (not depicted) that extends between the complementary mold halves. The slide bars 204 and 206 are movable along a direction (not depicted) that extends orthogonal to the axis extending between the complementary mold halves. Preferably, the connecting bars 214 and 212 are connected to the slide bars 204 and 206 respectively. Another actuator (not depicted) is connected to the connecting bar 212.

When the stripper plate 202 is actuated to move by a hydraulic actuator or other mechanism (not depicted) along an axis extending between the complementary mold halves, the actuator 216 moves the slide bar 204 along the direction that extends orthogonal to that axis.

The actuator 216 urges the connecting bar 214 to move, which in turn moves the slide bar 204 that shuttles or moves the mold portion 208 (which is attached to the slide bar 204).

In a first variation, the actuator 216 is mounted to the stripper plate 202. Lateral (side to side) motion of the slide bars 204 and 206 and front-to-back motion of the stripper plate 202 are independently controllable by separate actuators.

In a second variation, the actuator 216 is controlled by a built-in central processing unit (not depicted) or micro controller device, which is then controlled by a supervisory data processing system and/or a programmable logic controller, and any combination and permutation thereof.

In a third variation, the actuator 216 is controlled with a built-in logic chip, which is programmed or controlled/programmed by way of physical switches that are toggled to a selectable binary state that reflects a desired travel path for the slide bar 204.

In an alternative embodiment, the device 200 is configured as a tool for designing a cam shape of a cam, for testing new preform extraction profiles for a proposed cam, and/or for researching and identifying cam profiles (that is, a preferred preform extraction profile shape for selected types of preforms). The advantage associated with the alternative embodiments is reduction of design time and cost associated with identifying cam profiles used in the cam 118 of FIG. 1 for example. In addition, since preform manufacturers may be sensitive to certain types of preform defects, the device 200 can be used to optimize a preform extraction profile of a cam for avoiding specific preform defects. However, if a preform manufacturer is not sensitive to a certain preform defect, the cam 118 can be optimized to reduce other costs without concern for preform quality. According to the approach associated with the prior art, this would have been very difficult to do (if not outright impossible altogether) as it would be cost prohibitive to conduct trial and error tests with differently configured cams.

In an alternative, the molded article 308 is a preform. In another alternative embodiment, the molded article 308 is a polyethylene terephthalate (PET) preform.

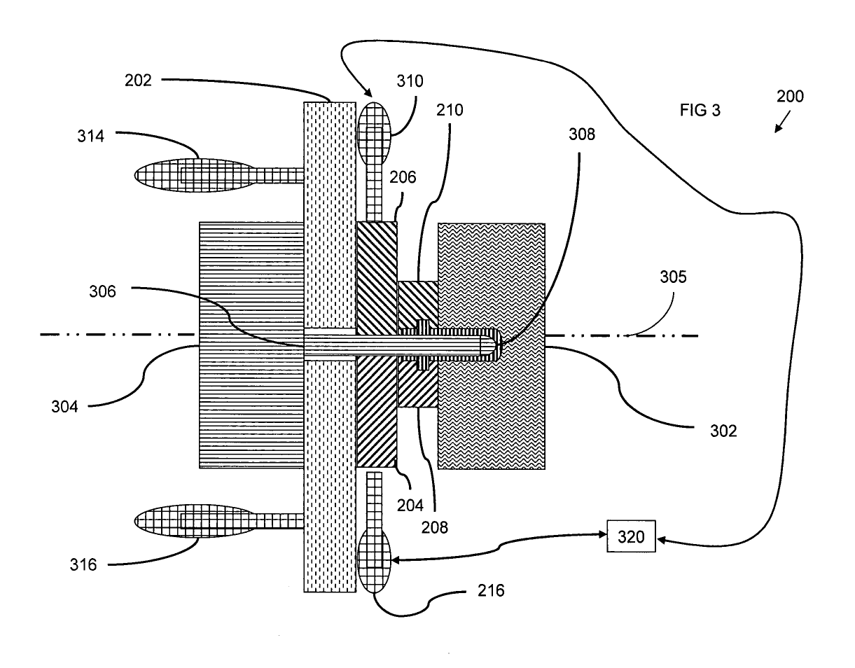

FIG. 3 is the cross sectional view along A-A of the device 200 of FIG. 2 for a mold closed position. Complementary mold halves 302 and 304 are depicted in the mold closed position, and they cooperate along with the mold portions 208 and 210 to mold a molded article 308. An axis 305 extends between the complementary mold halves 302 and 304. The axis 305 extends along a clamping direction of the complementary mold halves 302 and 304. The complementary mold half 302 includes a cavity side that defines a cavity therein. The complementary mold half 304 includes a core side having a core 306 extending therefrom and cooperating with the cavity. The slide bars 204 and 206 face the complementary mold half 302 while the stripper plate 202 faces the complementary mold half 304. Actuators 314 and 316 (or equivalents thereof) shuttle the stripper plate 202 back and forth along the axis 305 between the complementary mold halves 302 and 304 when they are in the open position. An actuator 310 (which is similar to the actuator 216) moves the slide bar 206. The actuators 216 and 310 move their respective slide bars 204 and 206 from side to side relative to the axis 305. A data processing system (DPS) 320 is connected to the actuators 216 and 310. The DPS 320 issues actuation signals to the actuators 216 and 310 in accordance to control logic which is described in detail below.

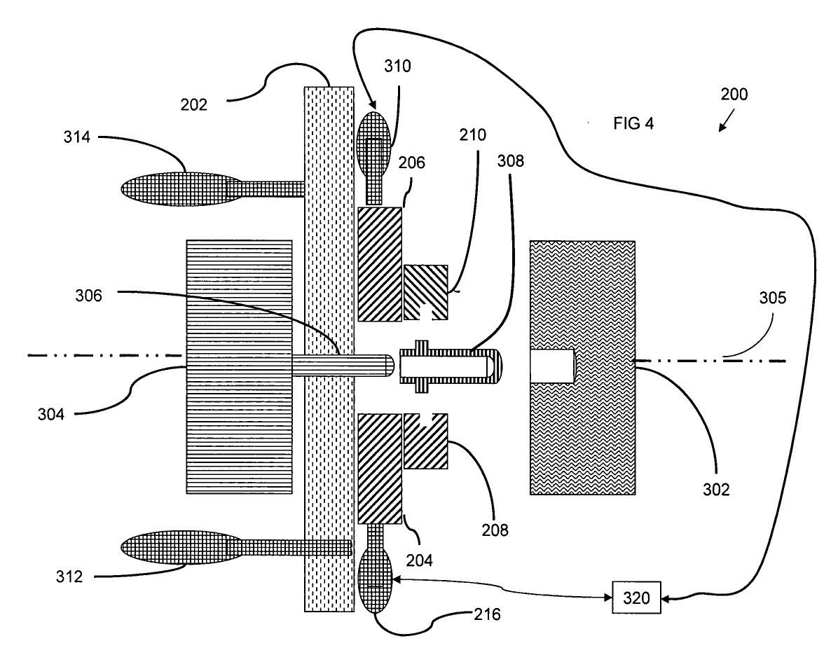

FIG. 4 is the cross sectional view along A-A of the device 200 of FIG. 2 for a mold opened position. The complementary mold halves 302 and 304 are depicted in the mold opened position. The complementary mold halves 302 and 304 are shown shuttled apart from each other so that the preform 308 may be removed from the mold cavity defined in the mold half 302 once the actuators 216 and 310 move the slide bars 204 and 206 respectively apart from each other.

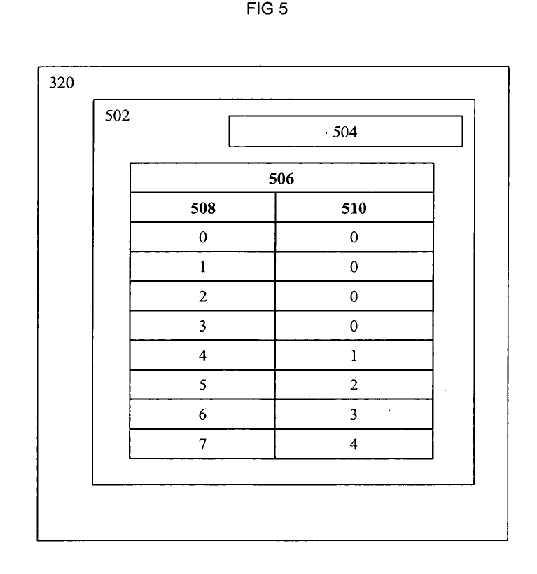

FIG. 5 is the schematic diagram of the DPS 320 of FIG. 3 that is usable with the device 200 of FIG. 2. Generally, the DPS 320 includes a central processing unit (hereinafter referred to as the “CPU”: not depicted) that is operatively coupled to a memory 502. The memory 502 is a medium that is readable and/or usable by the DPS 320. The memory 502 includes a set of programmed instructions 504 (that is, the control logic) that is readable and executable by the CPU. The control logic is depicted in detail further below. The memory 502 also includes a look-up table 506. The look-up table 506 includes a column 508 and a column 510. The look-up table 506 includes a set of selectable relative positions of the stripper plate 202 and the slide bar 204, and the actuators 216 and 310 are required to move or shuttle their respective slide bars to the selectable positions as identified in the column 510. A top-most row of the look-up table 506 represents a “load” position in which the molded article is “loaded” into the mold halves 302 and 304 of FIG. 3. The “load” position is the position in which the preform 308 has been molded and is ready to be removed from the complementary mold halves 302 and 304. By way of example, the “load” position may be considered as an “origin” position used to compute and/or measure “relative” distances in connection with the movement of the slider bars 204, 206 and the stripper plate 202 relative to the “origin” position. The bottom-most row of the look-up table 506 represents an “unload” position in which the molded article has been “unloaded” or ejected (i.e.; removed) from the complementary mold halves 302 and 304, and the molded article may then merely fall or drop onto a conveyor assembly (not depicted) or alternatively may be picked by an EOAT (End of Arm Tool: not depicted). The relative position of the stripper plate 202 and the slide bars 204, 206 are the positions relative to an arbitrarily selected origin. A position sensor can be a sensor that is a separate item from the actuator, or more preferably, the position sensor is integral with the actuator. The “non-integral” position sensor is not depicted. In a variation, the linear actuator 216 is a DC servomotor that includes an output shaft that is positioned by sending a coded signal to the servomotor, and also includes a motor encoder feedback mechanism that provides continuous output of position (either an analog signal or a digital signal). In another variation, the actuator 216 includes a servo control mechanism in which a cylinder has external devices that feedback a signal to give position information. In another variation, the actuator 216 includes an integral sensor that monitors position and/or proximity. Preferrably, the actuator 216 is of the type that is a “multi-position” type actuator in which the actuator 216 includes an arm that is actuated to different positions along its stroke and not just stoke the arm between the endpoints of the travel of the arm.

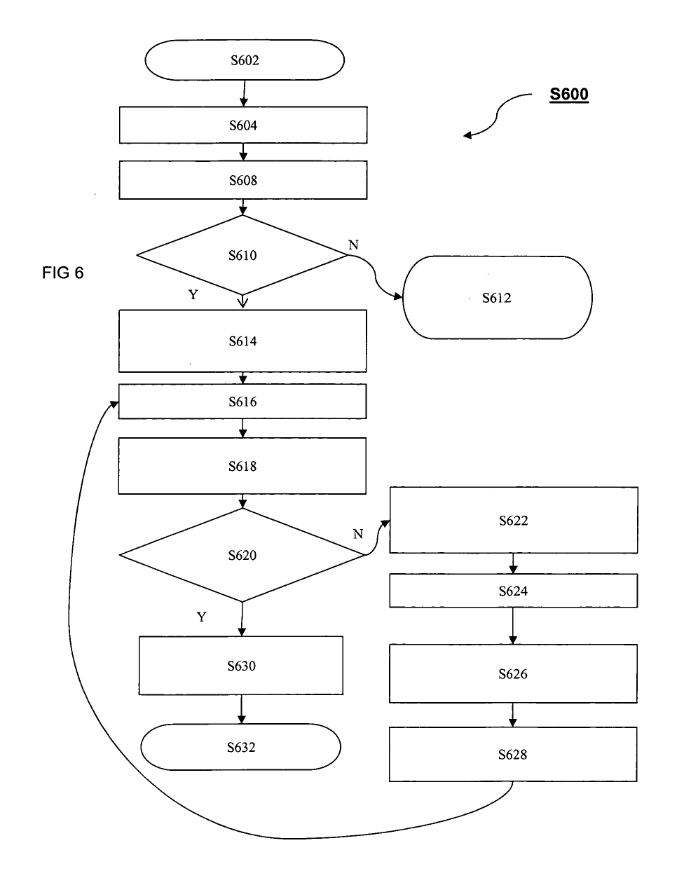

FIG. 6 is the flow chart of programmed removal instructions S600 (the control logic) for directing the DPS 320 of FIG. 5 to control and direct the actuators 216 and 310 to shuttle the slide bars 204 and 208 respectively according to the requirements set out in the control logic. The programmed instructions, in effect, control the actuators 216 and 310, and the actuators 216 and 310 respond by moving the slide bars 204 and 206 respectively towards selectable positions (as indicated in column 510 of the look-up table 506). The selectable positions are located between travel terminus points (that are associated with the actuators 216 and 310). The travel terminus points are indicated in the look-up table 506 at the top-most row (an end terminus point) and the bottom-most row (another end terminus point) of the table 506.

The instructions S600 include operation S602 to operation S632, which are as follows:

Operation S602 includes starting a molded article removal or ejection cycle.

Operation S604 includes reading a stripper plate sensor (not depicted) that provides a relative position of the stripper plate 202. The stripper plate sensor can be mounted in a convenient location. The relative position of the stripper plate 202 is a position relative to an arbitrarily selected origin.

Operation S608 includes reading a slide bar position sensor (not depicted) that provides a relative position of the slide bar 204. The slide bar position sensor can be mounted in a convenient location. The relative position of the slide bar 204 is a position relative to an arbitrarily selected origin.

Operation S610 includes determining whether the slide bar 204 and the stripper plate 202 are currently positioned at an origin (that is, the origin is a first row of the look-up table 506). If they are located at the origin, then control is transferred over to operation S614. If they are not located at the origin, the control is transferred over to operation S612.

Operation S612 includes terminating operation S600 due to an error. The error is the stripper plate and slide bar are not located at the origin at the beginning of the removal cycle.

Operation S614 includes initiating forward movement of the stripper plate 202 away from the complementary mold half 304 and towards the complementary mold half 302 by actuating the actuators 314 and 316.

Operation S616 includes reading the stripper plate sensor to determine the relative position of the stripper plate 202 (that is, the relative position is a position relative to an arbitrarily selected origin).

Operation S618 includes locating a stripper plate position X-coordinate from the column 508 of the look-up table 506.

Operation S620 includes determining whether the stripper plate 202 is located at a full stroke position (that is, the stripper plate 202 is located close to the complementary mold half 302). If the stripper plate 202 is located at the full stroke, then operation is transferred over to operation S630. If the stripper plate 202 is not located at the full stroke position, then control is transferred over to operation S622.

Operation S622 includes selecting a corresponding Y-coordinate (from the column 510 of the look-up table 506) in which the corresponding Y-coordinate is the Y-coordinate closest to the located stripper plate position X-coordinate (as determined above).

Operation S624 includes reading the slide bar sensor to determine the current position of the slide bar 204.

Operation S626 includes generating a correction signal based on the selected Y-coordinate and most recently-read slide bar position.

Operation S628 includes sending a correction signal to the slide bar actuator 216, and the actuator 216 responds accordingly, and then control is transferred over to operation S616 and the control logic is re-iterated.

Operation S630 includes stopping forward movement of the stripper plate 202.

Operation S632 includes ending the molded article removal cycle.

In an alternative, the programmed instructions direct the DPS 320 to control the actuator 216 responsive to selectable relative positions of the slide bar 204 and selectable relative positions of the stripper plate 202.

In another alternative, the programmed instructions direct the DPS 320 to control the actuator 216 responsive to determined relative positions of the slide bar 204 and of the stripper plate 202 compared against selectable relative positions of the slide bar 204 and selectable relative positions of the stripper plate 202.

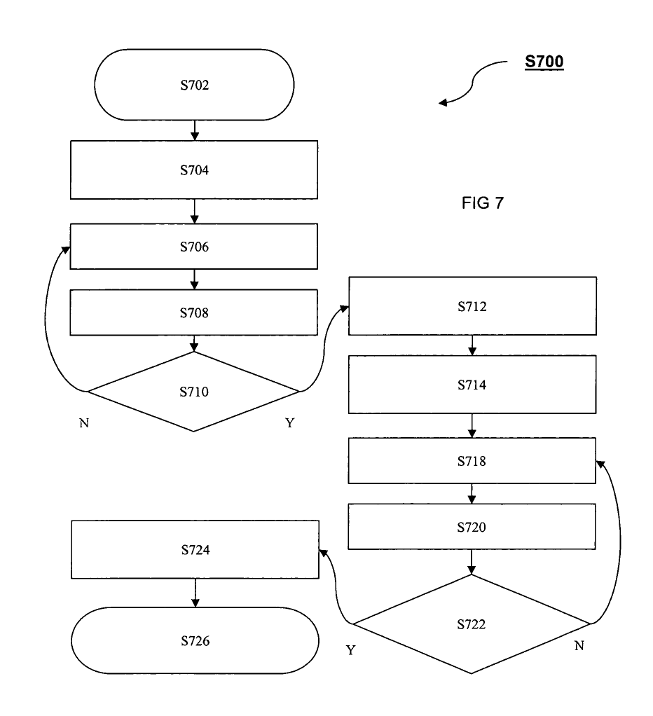

FIG. 7 is a flow chart of programmed reset instructions S700 for directing the DPS 320 of FIG. 5 to control and direct the device 200 to a reset position. The reset position is the end terminus point indicated in the top-most row of the look-up table 506 of FIG. 5.

The instructions S700 include operations S702 to S726, as follows:

Operation S702 includes starting a reset cycle.

Operation S704 includes initiating reverse movement of the stripper plate 202 by way of energizing the actuators 314 and 316.

Operation S706 includes reading the stripper plate sensor.

Operation S708 includes comparing the stripper plate position as provided by the sensor to values in the column 508 of the look-up table 506

Operation S710 includes determining whether the stripper plate 202 is currently located at the origin. If the stripper plate is not currently located at the origin, the control is transferred over to operation S706. If the stripper plate 202 is currently located at the origin, then control is transferred over to operation S712.

Operation S712 includes stopping actuation of the stripper plate 202.

Operation S714 includes initiating reverse movement of the slide bar 204.

Operation S718 includes reading the slide bar sensor.

Operation S720 includes comparing the currently determined slide bar relative position to the column 510 of the look-up table 506.

Operation S722 includes determining whether the slide bar 204 is currently positioned at the origin. If the slide bar 204 is not currently located at the origin, the control is transferred over to operation S718. If the slide bar 204 is currently located at the origin, then control is transferred over to operation S724.

Operation S724 includes stopping actuation of the slide bar 204.

Operation S726 includes ending the reset cycle.

The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

1. A molded article handling device of a molding machine, comprising:
a slide bar configured to:
have a mold portion configured to mold, in cooperation with complementary mold halves of a molding machine, a molded article, and
be actuatable by an actuator, the actuator configured to move the slide bar towards a plurality of selectable positions, the plurality of selectable positions located between travel terminus points.

2. The molded article handling device of claim 1, further comprising:
another slide bar configured to:
have another mold portion configured to mold, in cooperation with the complementary mold halves, the molded article, and
be actuated by another actuator, the another actuator configured to move the another slide bar at selectable positions located between other end-travel terminus points.

3. The molded article handling device of claim 1, wherein:
the slide bar includes a neck cooling ring configured to mold, in cooperation with the complementary mold halves, the molded article.

4. The molded article handling device of claim 1, wherein:
the slide bar is configured to be movable by the actuator along a direction extending substantially orthogonal to an axis, and the axis extends between the complementary mold halves.

5. The molded article handling device of claim 1, wherein:
the slide bar is configured to be movable, by a stripper plate, along the axis extending between the complementary mold halves.

6. The molded article handling device of claim 1, wherein:
the actuator is configured to be controllable by a data processing system, the data processing system is configured to execute responsive to reading selectable programmed instructions.

7. The molded article handling device of claim 6, wherein:
the data processing system includes memory; and
the selectable programmed instructions are embodied in the memory.

8. The molded article handling device of claim 6, wherein:
the slide bar is configured to be movable, by a stripper plate, along the axis extending between the complementary mold halves; and
the selectable programmed instructions are configured to direct the data processing system to control the actuator responsive to determined relative positions of the slide bar and of the stripper plate.

9. The molded article handling device of claim 8, wherein:
the relative positions are sensed by sensors, the sensors are configured to operatively connect to the data processing system.

10. The molded article handling device of claim 6, wherein:
the slide bar is configured to be movable, by a stripper plate, along the axis extending between the complementary mold halves; and
the selectable programmed instructions are configured to direct the data processing system to control the actuator responsive to selectable relative positions of the slide bar and selectable relative positions of the stripper plate.

11. The molded article handling device of claim 6, wherein:
the slide bar is configured to be movable, by a stripper plate, along the axis extending between the complementary mold halves; and
the selectable programmed instructions are configured to direct the data processing system to control the actuator responsive to determined relative positions of the slide bar and of the stripper plate compared against selectable relative positions of the slide bar and selectable relative positions of the stripper plate.

12. The molded article handling device of claim 11, wherein:
the relative positions are sensed by sensors, the sensors are configured to operatively connect to the data processing system.

13. The molded article handling device of claim 6, wherein:
the slide bar is configured to be movable, by a stripper plate, along the axis extending between the complementary mold halves; and
the selectable positions of the slide bar relative to the stripper plate are contained in a look-up table stored in the memory, the memory is configured to operatively cooperate with the data processing system.

14. The molded article handling device of claim 1, wherein:
the complementary mold halves include:
a first mold half having a core side; and
a second mold half defining a cavity side, the cavity side configured to cooperate with the core side.

15. The molded article handling device of claim 1, wherein:
the complementary mold halves include:
a first mold half having a core side, and
a second mold half defining a cavity side, the cavity side is configured to cooperate with the core side;
the slide bar is configured to be movable, by a stripper plate, along the axis extending between the complementary mold halves;
the stripper place faces the core side; and
the slide bar faces the cavity side.

16. The molded article handling device of claim 1, wherein:
the molded article is a preform.

17. The molded article handling device of claim 1, wherein:
the molded article is a polyethylene terephthalate (PET) preform.

18. An apparatus, comprising:
complementary mold halves of a molding machine; and
a molded article handling device, including:
a slide bar configured to:
have a mold portion configured to mold, in cooperation with the complementary mold halves, a molded article, and
be actuated by an actuator, the actuator configured to move the slide bar towards selectable positions, the selectable positions located between travel terminus points.

19. The apparatus of claim 18, further comprising:
another slide bar configured to:
have another mold portion configured to mold, in cooperation with the complementary mold halves, the molded article, and
be actuated by another actuator, the another actuator configured to move the another slide bar at selectable positions located between other end-travel terminus points.

20. The apparatus of claim 18, wherein:
the slide bar includes a neck cooling ring configured to mold, in cooperation with the complementary mold halves, the molded article.

21. The apparatus of claim 18, wherein:
the slide bar is configured to be movable by the actuator along a direction extending substantially orthogonal to an axis, and the axis extends between the complementary mold halves.

22. The apparatus of claim 18, wherein:
the slide bar is configured to be movable, by a stripper plate, along the axis extending between the complementary mold halves.

23. The apparatus of claim 18, wherein:
the actuator is configured to be controllable by a data processing system, the data processing system is configured to execute responsive to reading selectable programmed instructions.

24. The apparatus of claim 23, wherein:
the data processing system includes memory; and
the selectable programmed instructions are embodied in the memory.

25. The apparatus of claim 23, wherein:
the slide bar is configured to be movable, by a stripper plate, along the axis extending between the complementary mold halves; and
the selectable programmed instructions are configured to direct the data processing system to control the actuator responsive to determined relative positions of the slide bar and of the stripper plate.

26. The apparatus of claim 25, wherein:
the relative positions are sensed by sensors, the sensors are configured to operatively connect to the data processing system.

27. The apparatus of claim 23, wherein:
the slide bar is configured to be movable, by a stripper plate, along the axis extending between the complementary mold halves; and
the selectable programmed instructions are configured to direct the data processing system to control the actuator responsive to selectable relative positions of the slide bar and selectable relative positions of the stripper plate.

28. The apparatus of claim 23, wherein:
the slide bar is configured to be movable, by a stripper plate, along the axis extending between the complementary mold halves; and
the selectable programmed instructions are configured to direct the data processing system to control the actuator responsive to determined relative positions of the slide bar and of the stripper plate compared against selectable relative positions of the slide bar and selectable relative positions of the stripper plate.

29. The apparatus of claim 28, wherein:
the relative positions are sensed by sensors, the sensors are configured to operatively connect to the data processing system.

30. The apparatus of claim 23, wherein:
the slide bar is configured to be movable, by a stripper plate, along the axis extending between the complementary mold halves; and
the selectable positions of the slide bar relative to the stripper plate are contained in a look-up table stored in the memory, the memory is configured to operatively cooperate with the data processing system.

31. The apparatus of claim 18, wherein:
the complementary mold halves includes:
a first mold half having a core side; and
a second mold half defining a cavity side, the cavity side configured to cooperate with the core side.

32. The apparatus of claim 18, wherein:
the complementary mold halves include:
a first mold half having a core side, and
a second mold half defining a cavity side, the cavity side is configured to cooperate with the core side;
the slide bar is configured to be movable, by a stripper plate, along the axis extending between the complementary mold halves;
the stripper place faces the core side; and
the slide bar faces the cavity side.

33. The apparatus of claim 18, wherein:
the molded article is a preform.

34. The apparatus of claim 18, wherein:
the molded article is a polyethylene terephthalate (PET) preform.

35. A system, comprising:
a molding machine;
complementary mold halves cooperating with the molding machine; and
a molded article handling device, including:
a slide bar configured to:
have a mold portion configured to mold, in cooperation with the complementary mold halves, a molded article, and
be actuated by an actuator, the actuator configured to move the slide bar towards selectable positions, the selectable positions located between travel terminus points.

36. The system of claim 35, further comprising:
another slide bar configured to:
have another mold portion configured to mold, in cooperation with the complementary mold halves, the molded article, and
be actuated by another actuator, the another actuator configured to move the another slide bar at selectable positions located between other end-travel terminus points.

37. The system of claim 35, wherein:
the slide bar includes a neck cooling ring configured to mold, in cooperation with the complementary mold halves, the molded article.

38. The system of claim 35, wherein:
the slide bar is configured to be movable by the actuator along a direction extending substantially orthogonal to an axis, and the axis extends between the complementary mold halves.

39. The system of claim 35, wherein:
the slide bar is configured to be movable, by a stripper plate, along the axis extending between the complementary mold halves.

40. The system of claim 35, wherein:
the actuator is configured to be controllable by a data processing system, the data processing system is configured to execute responsive to reading selectable programmed instructions.

41. The system of claim 40, wherein:
the data processing system includes memory; and
the selectable programmed instructions are embodied in the memory.

42. The system of claim 40, wherein:
the slide bar is configured to be movable, by a stripper plate, along the axis extending between the complementary mold halves; and
the selectable programmed instructions are configured to direct the data processing system to control the actuator responsive to determined relative positions of the slide bar and of the stripper plate.

43. The system of claim 42, wherein:
the relative positions are sensed by sensors, the sensors are configured to operatively connect to the data processing system.

44. The system of claim 40, wherein:
the slide bar is configured to be movable, by a stripper plate, along the axis extending between the complementary mold halves; and
the selectable programmed instructions are configured to direct the data processing system to control the actuator responsive to selectable relative positions of the slide bar and selectable relative positions of the stripper plate.

45. The system of claim 40, wherein:
the slide bar is configured to be movable, by a stripper plate, along the axis extending between the complementary mold halves; and
the selectable programmed instructions are configured to direct the data processing system to control the actuator responsive to determined relative positions of the slide bar and of the stripper plate compared against selectable relative positions of the slide bar and selectable relative positions of the stripper plate.

46. The system of claim 45, wherein:
the relative positions are sensed by sensors, the sensors are configured to operatively connect to the data processing system.

47. The system of claim 40, wherein:
the slide bar is configured to be movable, by a stripper plate, along the axis extending between the complementary mold halves; and
the selectable positions of the slide bar relative to the stripper plate are contained in a look-up table stored in the memory, the memory is configured to operatively cooperate with the data processing system.

48. The system of claim 35, wherein:
the complementary mold halves includes:
a first mold half having a core side; and
a second mold half defining a cavity side, the cavity side configured to cooperate with the core side.

49. The system of claim 35, wherein:
the complementary mold halves include:
a first mold half having a core side, and
a second mold half defining a cavity side, the cavity side is configured to cooperate with the core side;
the slide bar is configured to be movable, by a stripper plate, along the axis extending between the complementary mold halves;
the stripper place faces the core side; and
the slide bar faces the cavity side.

50. The system of claim 35, wherein:
the molded article is a preform.

51. The system of claim 35, wherein:
the molded article is a polyethylene terephthalate (PET) preform.
